(19) United States
(12) Patent Application Publication
(10) Pub. No.: US 2026/0016103 A1
(43) Pub. Date: Jan. 15, 2026

(54) PIPE SUPPORT SYSTEM

(71) Applicant: ERICO International Corporation, Solon, OH (US)

(72) Inventor: Scott Ernest Anderson, Garrettsville, OH (US)

(21) Appl. No.: 19/267,837

(22) Filed: Jul. 14, 2025

Related U.S. Application Data
(60) Provisional application No. 63/671,353, filed on Jul. 15, 2024.

(51) Int. Cl. F16L 3/02; F16L 3/10

(52) U.S. Cl. CPC F16L 3/02; F16L 3/1091

(57) ABSTRACT

The present disclosure provides a support system. The support system may include a bracket that includes a bracket body and one or more arms fastened to the bracket body. The bracket body may include a support wall extending to an upper bracket end that defines a support surface for a pipe. The one or more arms may include a first arm fastened to the support wall with a first fastener extending through a first support aperture of the support wall. The first arm may extend away from the first fastener to a first free end with a first end aperture configured to secure a pipe flange. The first arm may be slidable along the first support aperture over a first continuous range of arm positions and the first fastener may be operable to secure the first arm at any position along the first continuous range of arm positions.

### CROSS REFERENCE TO RELATED APPLICATIONS

This application claims priority to U.S. Provisional Application No. 63/671,353, filed on Jul. 15, 2024, the contents of which is incorporated by reference herein in its entirety.

### BACKGROUND

In many applications, it may be useful to elevate pipe and conduit on a rooftop, in a building, or on a ground surface. Conventionally, pipe support systems are used to secure and support pipe and conduit.

### SUMMARY

Some embodiments of the invention provide a support system for pipes. The support system may include a base, a post secured to and extending upwardly from the base, and a bracket secured to the post and supported by the post relative to the base. The bracket may include a bracket body including a support wall and a base secured to the post, the support wall extending integrally from the base. The support wall may include an upper end defining a first support section and a second support section. The second support section may extend at a non-parallel angle relative to the first support section so that the first and second support sections collectively define a support surface for a pipe. The support wall may include first parallel slots extending through the support wall below the first support section of the upper end, and may include second parallel slots extending through the support wall below the second support section of the upper end. The bracket may include a first arm including a first aperture to receive a first fastener to secure a pipe flange. The first arm may be secured at the first parallel slots and may be slidable along the first parallel slots to provide a first continuous range of arm positions. The bracket may also include a second arm including a second aperture to receive a second fastener to secure the pipe flange. The second arm may be secured at the second parallel slots and may be slidable along the second parallel slots to provide a second continuous range of arm positions. The first and second arm may be individually slidably adjustable to collectively provide a plurality of first support configurations for the pipe with the first and second arms at any arm position along the respective first or second continuous ranges of arm positions.

Some embodiments of the invention provide a support system for pipes. The support system may include a bracket that includes a bracket body and one or more arms fastened to the bracket body. The bracket body may include a support wall extending to an upper bracket end that defines a support surface for a pipe. The one or more arms may include a first arm fastened to the support wall with a first fastener extending through a first support aperture of the support wall. The first arm may extend away from the first fastener to a first free end with a first end aperture configured to secure a pipe flange. The first arm may be slidable along the first support aperture over a first continuous range of arm positions and the first fastener may be operable to secure the first arm at any position along the first continuous range of arm positions, including first arm positions that align the first free end of the first arm above the support surface to support the pipe flange.

Some embodiments of the invention provide a method for securing a pipe to a support system. The method may include providing a bracket including a bracket body including a support wall extending to an upper bracket end that defines a support surface for a pipe, and one or more arms fastened to the bracket body. The one or more arms may include a first arm fastened to the support wall with a first fastener extending through a first support aperture of the support wall. The first fastener may be operable to secure the first arm at any position along a first continuous range of arm positions. The first arm may extend away from the first fastener to a first free end with a first end aperture configured to secure a pipe flange. The method may include sliding the first arm along the first support aperture over the first continuous range of arm positions. The method may include securing the first arm with the first fastener at a first arm position along the first continuous ranges of arm positions that aligns the first free end of the first arm above the support surface to support the pipe flange.

### BRIEF DESCRIPTION OF THE DRAWINGS

The accompanying drawings, which are incorporated in and form a part of this specification, illustrate embodiments of the invention and, together with the description, explain the principles of embodiments of the invention:

FIG. 1 is an axonometric view of a support system according to an embodiment of the invention.

FIG. 2 is an axonometric view of the support system of FIG. 1, supporting a length of pipe in a first configuration.

FIG. 3 is a rear elevation view of the support system of FIG. 1.

FIG. 4 is an axonometric view of a cross-section of the support system of FIG. 1, taken at IV-IV of FIG. 3.

FIG. 5 is a front elevation view of an embodiment of a bracket of the support system of FIG. 1, including arms in a first position.

FIG. 6 is a front elevation view of the bracket of FIG. 5, including the arms in a second position.

FIG. 7 is a front elevation view of the bracket of FIG. 5, including the arms in a third position.

FIG. 8 is a front elevation view of the bracket of FIG. 5, supporting the length of pipe in a second configuration.

FIG. 9 is an axonometric view of the bracket of FIG. 5, including a bracket extension.

FIG. 10 is a front axonometric view of the bracket of FIG. 9.

FIG. 11 is a front elevation view of a bracket of the support system of FIG. 1 according to an embodiment of the invention, including arms in a fourth position.

FIG. 12 is a front elevation view of the bracket of FIG. 11, including the arms in a fifth position.

FIG. 13 is a front elevation view of the bracket of FIG. 11, including the arms in a sixth position.

FIG. 14 is a front elevation view of the bracket of FIG. 11, supporting the length of pipe.

FIG. 15 is a front elevation view of an embodiment of a bracket of the support system of FIG. 1.

FIG. 16 is an axonometric view of the bracket of FIG. 15.

FIG. 17 is a front elevation view of an embodiment of a bracket of the support system of FIG. 1.

FIG. 18 is an axonometric view of the bracket of FIG. 17.

FIG. 19 is a front elevation view of an embodiment of a bracket of the support system of FIG. 1.

FIG. 20 is an axonometric view of the bracket of FIG. 19.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to elevate equipment (e.g., pipe and conduit) above the ground (e.g., the earth, a roof surface, etc.). Elevating the equipment above a support surface may ease the performance of maintenance on the pipe, may aid the organization of multiple crossing lines of pipe, and in some cases may be required by building codes. Additionally, elevating equipment such as pipe above the support surface may allow installers to slope the pipe, to mitigate the accumulation of water or other fluids in unwanted areas of a pipe system.

Many pipe systems include pipes that extend from a first pipe end to a second pipe end. An extension of the pipe disposed between the first pipe end and the second pipe end generally defines a smaller diameter than flanges that are disposed at the first and second pipe ends to connect the pipes together. Conventional support systems are generally configured to elevate and secure either the flanges disposed at either end of the pipe, or the pipe extension extending between the first pipe end and the second pipe end. Specifically, conventional support systems generally cannot readily support and secure both the flanges of the pipe and the pipe extension disposed between the flanges. As such, installers are generally required to store, transport, and switch between two different support systems, based on a desired position of the support system along the pipe.

Examples of the disclosed technology may address these and other issues, including by providing a single support system capable of securing and supporting a length of pipe, conduit, or other equipment at any selected position along the pipe (e.g., at or between flanges of the pipe). For example, through the use of readily adaptable modular brackets and related components, some examples of the disclosed technology can reduce a number of different components and a number of different support systems needed to elevate and secure equipment as compared to conventional designs.

Further, some examples can provide bracket structures with improved ease of installation and robustness in service. In some cases, such bracket structures can allow for easier customization of the support system, including to adapt (e.g., increase or decrease) a support system to elevate and secure pipe of different diameters.

Some examples of the disclosed technology can also allow a height of the support system to be quickly changed (e.g., to provide a different support height for the equipment), including via telescoping rods. Thus, for example, some implementations can be readily adjustable to account for different height regulations regarding support systems for equipment such as pipes and conduit, to accommodate other rooftop structures (e.g., other pipe), or to address various other considerations for installation and service.

In some examples, a support system includes a base, a post extending upward from the base, a telescoping rod threadedly coupled to the post, and a bracket coupled to the telescoping rod. In some configurations the bracket is configured to receive and support a pipe, a conduit, or other elongate member in a larger pipe system. In some configurations, a bracket can be provided without a base or telescoping support, to be secured relative to a support surface in various ways known in the art.

In some examples, the bracket can be configurable to selectively secure either a flange of the pipe, or an extension of the pipe extending between flanges of the pipe. For example, the bracket can be secured to the flanges in a first installation configuration by utilizing arms of the bracket that can receive and retain fasteners that extend through apertures disposed around a perimeter of the flanges of the pipe. The arms can be readily adjustable-rotationally or translationally-between a plurality of arm positions to allow the arms to be secured to pipes and pipe flanges having a variety of different configurations and diameters. Furthermore, the arms may be continuously slidable (e.g., translatable) over a range of arm positions to secure pipes or the pipe flanges thereof. Providing continuous adjustability of the arms along the range of arm positions allows the arms to be positioned anywhere along the range of arm positions, and increases the compatibility of the bracket with the variety of different pipes and pipe flanges.

Additionally, in some examples, the bracket can secure extensions of the pipe in a second installation configuration by tightening and securing the pipe within a notch of the bracket (e.g., utilizing a U-bolt secured to the bracket).

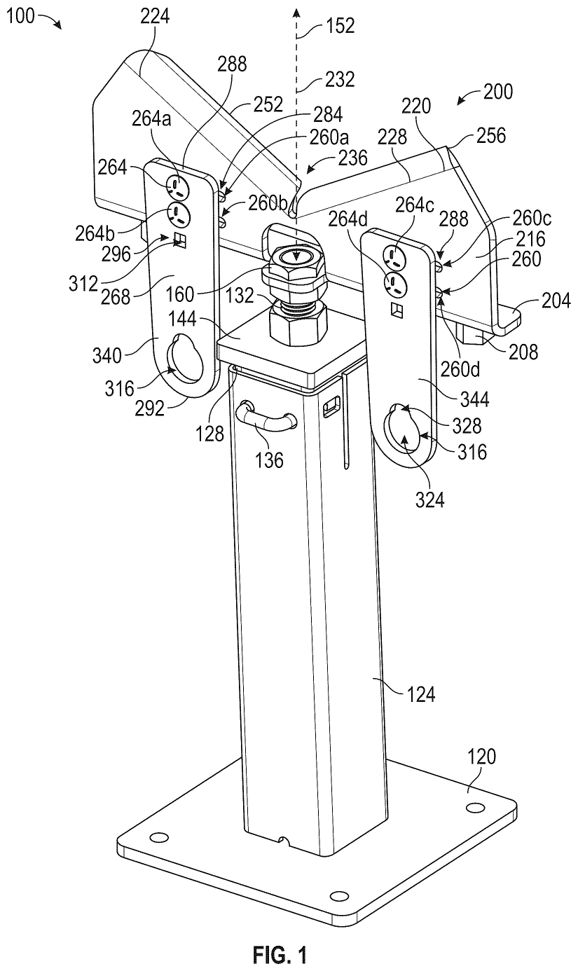

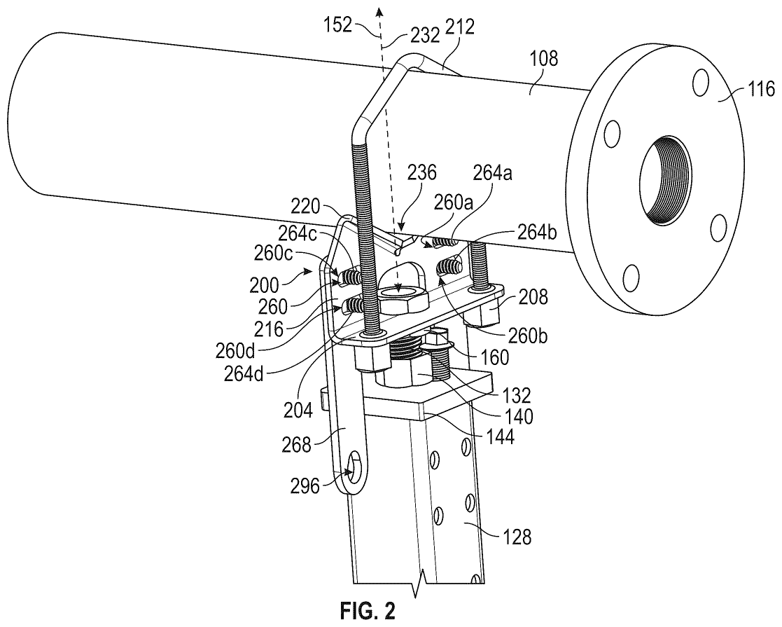

As one example, FIG. 1 illustrates a support system for supporting equipment, including as can be installed on flat rooftops, interior or exterior concrete decks, or on other support surfaces. In the example shown, the support system includes an adjustable support structure 100 that may support and secure an elongate member 108 (e.g., pipe, conduit, or other elongate member as illustrated in FIG. 2) utilizing a bracket 200. The support structure 100 can be secured to flanges 116 (as shown in FIG. 2) disposed at either end of the pipe 108, or may instead be secured to an extension of the pipe 108 between the flanges 116 (as shown in FIG. 2). As further detailed below, the bracket 200 can be easily installed and adjusted to support elongate diameters having various diameters and features such as flanges, or other protruding features, so that various types and sizes of pipes, conduit, or other elongate members can be supported by the support system.

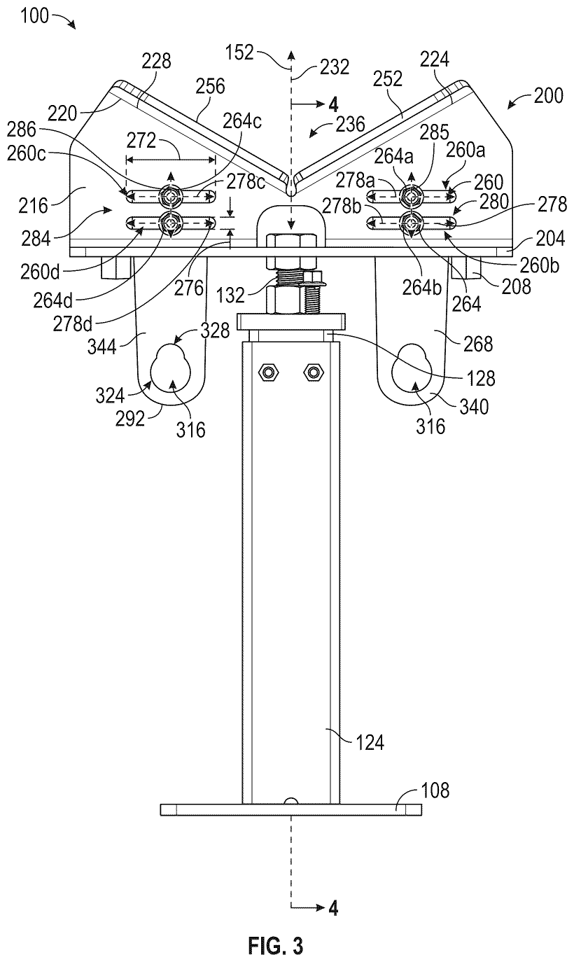

In the illustrated example, the support structure 100 includes a base 120, a first post 124, and the bracket 200. In other examples, other configurations are possible (e.g., with only the bracket 200, with only the base 120 and the bracket 200, with a different base, with a different post or other vertical support assembly, etc.). As described further below, the support structure 100 can further include a second post 128 slidably nested within the first post 124 (as shown in FIG. 3), a telescoping rod 132 for adjusting a height of the bracket 200, a first locking fastener 136 for locking an extension of the second post 128 relative to the first post 124, and a second locking fastener 140 for locking an extension of the telescoping rod 132 relative to the first or second post 124, 128.

The base 120 for the support structure 100 can generally exhibit a variety of shapes to provide stability to the support structure 100. As illustrated, the base 120 defines a rectangular prism shape. However, in other configurations, the base 120 may have a different shape (e.g., cylindrical, cuboid, or pyramidal).

Still referring to FIG. 1, the first post 124 can be a rounded rectangular tube (a tube defining a rectangular cross-sectional shape with rounded corners), however, the first post 124 may instead be a circular tube, a triangular tube, or a tube having another alternate cross-sectional shape. The first post 124 extends upward from the base 120. In some examples, the first post 124 may extend integrally from the base 120. However, in other embodiments, the first post 124 may be removably coupled to the base 120 to allow for increased modularity and potentially more compact transport of the support structure 100.

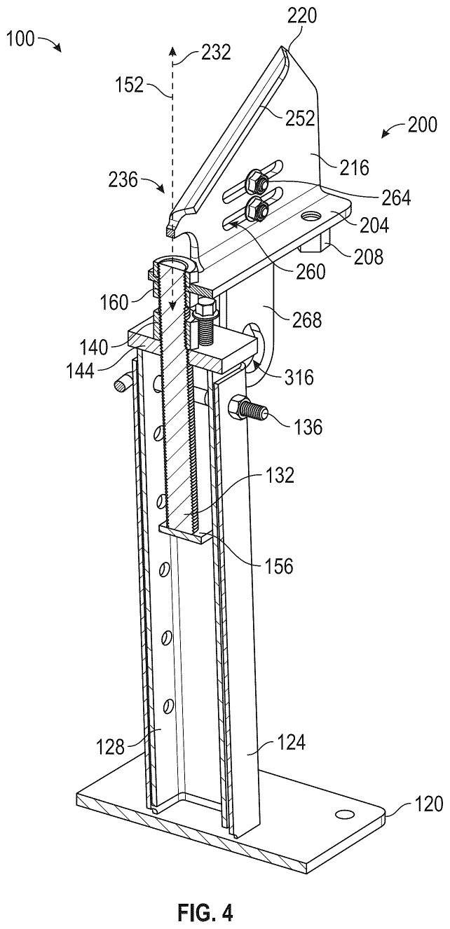

Referring to FIG. 4, the first post 124 extends from the base 120 to a first post aperture, disposed opposite the base 120. The first post aperture can be configured to receive the second post 128. In some embodiments, the second post 128 can be a rounded rectangular tube, however, the first post 124 may instead be a circular tube, a triangular tube, or a tube having another alternate cross-sectional shape. A cross-sectional shape of the first post aperture, as well as the cross-sectional shape of the first post 124, can be slightly larger than the cross-sectional shape of the second post 128 to allow the second post 128 to be slidably nested within the first post 124.

As illustrated in FIG. 4, the first post 124 may include one or more first post fastener apertures, and the second post 128 may include one or more second post fastener apertures. In some embodiments, the first and second post fastener apertures can be aligned by slidably adjusting the second post 128 within and relative to the first post 124. A first locking fastener 136 can then be extended through one or more sets of the aligned first and second post fastener apertures to lock a position of the second post 128 relative to the first post 124.

In some examples, the second post 128 can be capped by an upper plate 144 including a plurality of plate apertures. A first plate aperture is sized to slidingly receive the telescoping rod 132. A second plate aperture is configured to threadedly receive the second locking fastener 140 (e.g., a locking nut). The telescoping rod 132 may be threaded, so that the height of the telescoping rod 132 may be adjusted by sliding the rod 132 within the first plate aperture and rotationally adjusting the second locking fastener 140. In some examples, the rod 132 can be axially adjusted (e.g., slid) along an extension axis 152. The extension axis 152 can extend through a center of the rod 132 (e.g., through an axial center along a length of the rod 132). The extension axis 152 may therefore also extend through and substantially perpendicular to the upper plate 144 (e.g., through the first plate aperture). In some examples, the extension axis 152 can extend through a center of the first post 124 or a center of the second post 128.

In some examples, the telescoping rod 132 can be slid to an extended orientation (e.g., translated relative to the first post 124 and the second post 128). The second locking fastener 140 can then be moved (via rotation) along the telescoping rod 132 to be seated on the upper plate 144 of the second post 128. Thus located, the second locking fastener 140 can block any sliding retraction of the telescoping rod 132 while still allowing rotational adjustment in some cases (e.g., to properly orient the bracket 200). With the second locking fastener 140 in place and the telescoping rod 132 at a desired extension, the second locking fastener 140 can then be tightened to secure the second locking fastener 140 against further rotation and lifting—and, correspondingly, prevent lifting of the telescoping rod 132.

Still referring to FIG. 4, internal structures can also help to prevent undesired rotation of a bracket supported by a telescoping assembly (e.g., the telescoping rod 132, or other known telescoping support structures). For example, as shown the bottom of the telescoping rod 132 is coupled to a rod plate 156 that has a narrowed center portion that is non-rotationally secured to the telescoping rod 132 and widened opposing side portions that extend to be disposed at opposing sides of the post. This general shape can allow the plate 156 to contact one or more faces of the inner surface of the first or second post 124, 128 to prevent rotation of the telescoping rod 132 or, in some cases, to slide along the internal corners of the first or second post 124, 128. In particular, the illustrated profile of the rod plate 156 includes the opposing side portions that each include one or more lobes. Each of the lobes may include a rounded profile that projects outward from one of the side portions of the rod plate 156. The lobes of the rod plate 156 may be configured to contact the sides of the first or second post 124, 128 to prevent rotation of the telescoping rod 132. Thus, the rod plate 156 may prevent unwanted adjustments to the height of the telescoping rod 132 by preventing the telescoping rod 132 from turning and thereby changing extension height relative to the second locking fastener 140. The illustrated lobed shape of the plate 156 may be advantageous over a rectangular shaped plate, as the lobes of the rod plate 156 provide points of contact against the sides of the first or second post 124, 128 while reducing the amount of material needed when manufacturing the rod plate 156.

An end of the telescoping rod 132 extends upward from the upper plate 144 and is coupled to the bracket 200, so that the rod 132 supports the bracket 200 relative to the base 120. The bracket 200 may be threadedly coupled to the telescoping rod 132 in some configurations, or can be secured using other known approaches to provide a fixed or rotational coupling.

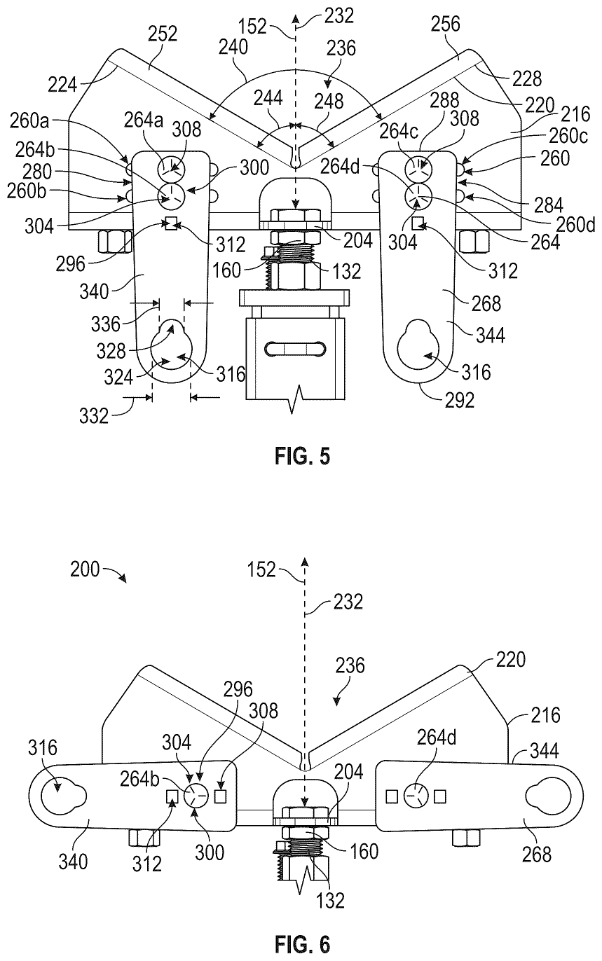

FIG. 5 depicts an enlarged view of the bracket 200. The bracket 200 can include a first wall 204 (e.g., a base) that is coupled to the rod 132. In some examples, the first wall 204 may be oriented substantially perpendicular to the extension axis 152. The bracket 200 can include a rod aperture that may receive the rod 132. Specifically, the rod aperture can be disposed in the first wall 204. In some examples, the rod aperture can be threaded, to threadedly secure the rod 132. In other examples, rod nuts 160 disposed on either side of the rod aperture can threadedly engage the rod 132 to secure the bracket 200 to the rod 132. Specifically, the rod nuts 160 can be tightened against the bracket 200 to mitigate axial movement of the bracket 200 along the extension axis 152. In such examples, although the bracket 200 may not be axially movable along the extension axis 152 (e.g., due to the rod nuts 160), the bracket 200 may be rotatable about the extension axis 152 to allow for rotational adjustment of the bracket 200 during installation. Additionally, in some examples, a height of the bracket 200 can be adjusted along the extension axis 152 by rotatably adjusting one of the rod nuts 160 (e.g., adjusting a position of the rod nuts 160 along the rod 132), and sliding the bracket 200 along the rod 132.

Referring briefly to FIG. 3, the first wall 204 can further include securement nuts 208. In some examples, securement nuts 208 can be configured for push-in engagement, to secure a threaded rod via axial translation of the rod into the nut(s) 208 without rotation. In other examples, the securement nuts 208 may be threaded, and rotatable relative to the first wall 204, to allow the securement nuts 208 to threadedly engage a threaded rod or bolt. Thus, for example, the securement nuts 208 may receive a U-bolt 212 (as shown in FIG. 2) to aid the securement of the pipe 108 to the bracket 200. The securement nuts 208 or other attachment devices known in the art can be secured to the first wall 204 (or the bracket 200 generally) using various applicable approaches. For example, the securement nuts 208 may include a flange that extends through securement holes disposed in the first wall 204, to couple the securement nuts 208 to the first wall 204, while allowing the nuts 208 to be rotated relative to the first wall 204.

In some examples, a second wall 216 (e.g., a support wall) extends from the first wall 204 to an upper end of the bracket 200. More specifically, the second wall 216 may extend integrally from the first wall 204. As illustrated in FIG. 1, the second wall 216 can extend substantially perpendicular to the first wall 204. The second wall 216 can extend to an upper edge 220, opposite the first wall 204, that includes a first edge section 224 and a second edge section 228. In some examples, the first edge section 224 can be connected to the second edge section 228. Specifically, a corner connecting the first edge section 224 and the second edge section 228 may be disposed along a centerline 232 (e.g., a plane or axis) that extends substantially parallel to the extension axis 152 and that bisects the second wall 216. However, in other examples, the centerline 232 may instead intersect one of the first edge section 224 or the second edge section 228. In some examples, the centerline 232 may also bisect the first wall 204. In some examples, the centerline 232 may extend along the extension axis 152.

Referring again to FIG. 5, the first edge section 224 can extend at a notch angle 240 relative to the second edge section 228 to form a notch 236 therebetween. As described further below, the notch 236 may receive the pipe 108, support the pipe 108, and aid securement of the pipe 108 to the bracket 200 (as shown in FIGS. 2 and 8). The notch angle 240 defined between the first edge section 224 and the second edge section 228 can be oblique (e.g., or otherwise non-parallel) in some cases. Specifically, the notch angle 240 may be about 120 degrees. In some examples, the notch angle 240 may be between about 100 degrees and about 170 degrees, or between about 100 degrees and about 150 degrees, or between about 100 degrees and 130 degrees. In other examples, the notch angle 240 may be greater than about 90 degrees.

In some examples, a first edge angle 244 may be defined between the first edge section 224 and the centerline 232. In some examples, the first edge angle 244 may be about 60 degrees. In other examples, the first edge angle 244 may be between about 40 degrees and about 80 degrees, or between about 50 degrees and about 70 degrees, or between about 55 degrees and about 65 degrees. Additionally, a second edge angle 248 may be defined between the second edge section 228 and the centerline 232. Similar to the first edge angle 244, the second edge angle 248 may be about 60 degrees. In other examples, the second edge angle 248 may be between about 40 degrees and about 80 degrees, or between about 50 degrees and about 70 degrees, or between about 55 degrees and about 65 degrees.

In some examples, the first edge angle 244 and the second edge angle 248 may be equal. For example, the first edge section 224 and the second edge section 228 may extend at equal and opposite angles relative to the extension axis 152. However, in other examples, the first edge angle 244 and the second edge angle 248 may not be equal.

Referring to FIG. 3, the first edge section 224 may include a first lip 252 (e.g., a wall or protrusion) that may extend from the first edge section 224 and a second lip 256 that may extend from the second edge section 228. In some examples, the first lip 252 and the second lip 256 may both extend substantially perpendicularly from the second wall 216 in a same direction. In such examples, similar to the first edge section 224 and the second edge section 228, the first lip 252 and the second lip 256 (e.g., a top surface thereof) may extend at the angle 240 relative to one another, such that the first lip 252 and the second lip 256 are non-parallel.

As illustrated in FIG. 5, the first lip 252 and the second lip 256 may be disconnected. For example, the first lip 252 and the second lip 256 may not extend from the corner between the first edge section 224 and the second edge section 228. In some examples, the first lip 252 and the second lip 256 being disconnected may ease the process of cutting and stamping the bracket 200.

In some examples, a combination of the first edge section 224 and the first lip 252 can create a first support portion of the upper end of the bracket 200. The first support portion may provide a contact area on which the pipe 108 can rest and be retained by the bracket 200 (as shown in FIG. 2).

Furthermore, a combination of the second edge section 228 and the second lip 256 can create a second support portion of the upper end of the bracket 200. The second support portion may provide a contact area of the upper end of the bracket 200 on which the pipe 108 can rest and be retained by the bracket 200 (as shown in FIG. 2).

In such examples, the first support portion and the second support portion may cooperatively form a support surface of the notch 236. The first and second support portions may therefore cooperatively support the pipe 108 within the notch 236. Specifically, the pipe 108 may rest on the first lip 252 and the second lip 256, and may be held within the notch 236 by gravity (as shown in FIG. 2). In some examples, the first lip 252 and the second lip 256 may increase a contact area between the bracket 200 and the pipe 108 resting within the notch 236. Specifically, a width of the first lip 252 and the second lip 256 measured perpendicular to the extension axis 152, or the centerline 232, may be greater than a width of the first edge section 224 and the second edge section 228, respectively. As such, the first lip 252 and the second lip 256 may increase a stability of the pipe 108 retained within the notch 236.

As described above, the first support portion and the second support portion may cooperatively form the notch 236. In such examples, similar to the first edge section 224 and the second edge section 228, the first support portion and the second support portion may extend at the angle 240 relative to one another, such that the first support portion and the second support portion are non-parallel.

Referring again to FIG. 3, the second wall 216 may include a plurality of support apertures 260 (e.g., support slots) extending through the second wall 216. As described further below, the support apertures 260 may receive arm fasteners 264 to selectively and adjustably couple the arms 268 to the bracket 200. Also as described further below, in some installation configurations, the arms 268 may aid the securement of the pipe 108 to the bracket 200.

In some examples, each of the support apertures 260 may define an elongate shape or an oblong shape. Specifically, each of the support apertures 260 may define a first support aperture width 272 measured along a first direction (e.g., an elongate direction) that can be larger than a second support aperture width 276 measured along a second direction that extends substantially perpendicular to the first direction. In some examples, the first support aperture width 272 of each of the support apertures 260 may be a largest dimension thereof.

In some examples, each of the support apertures 260 may include a support axis 278 that extends through the respective support aperture 260 parallel to the elongate direction, and perpendicular to the extension axis 152. In some examples, the support axis 278 of each of the support apertures 260 may extend along and parallel to the respective first support aperture widths 272. In such examples, each of the support apertures 260 may be linear slots, extending along the respective support axes 278. Furthermore, in such examples, the support axis 278 of each of the support apertures 260 may extend through a center of the respective support apertures 260 to bifurcate the respective support apertures 260.

In some examples, the support apertures 260 may define a stadium shape (e.g., a rectangle having two opposing rounded edges), a rectangular shape, an ovular shape, or any other elongate shape. In some examples, the first support aperture width 272, and therefore the support axis 278, of each of the support apertures 260 may extend along the first direction that may be substantially perpendicular to the centerline 232 and the extension axis 152. As described below, in such examples, the arm fasteners 264, and therefore the arms 268, may be adjusted (e.g., translated) within the support apertures 260 in a direction that is perpendicular to the centerline 232 and the extension axis 152.

In some examples, the plurality of support apertures 260 may be arranged in a vertical array (e.g., in vertical columns). Specifically, a first support aperture column 280 and a second support aperture column 284 may each include two of the plurality of support apertures 260, however, the first and second support aperture columns 280, 284 may instead include three or more of the plurality of support apertures 260. In some examples, the first support aperture column 280 and the second support aperture column 284 may be disposed on opposite sides of the centerline 232. For example, the second support aperture column 284 may mirror the first support aperture column 280 about the centerline 232. As described further below, the support apertures 260 being arranged in a vertical array can allow each of the arms 268 to be fastened to the bracket 200 utilizing two or more of the arm fasteners 264, to allow staging of the arms 268 during installation and to mitigate rotation of the arms 268 relative to the bracket 200 after installation.

Still referring to FIG. 3, in some examples, the first support aperture column 280 includes the support apertures 260 including a first support aperture 260a and a second support aperture 260b. Furthermore, the second support aperture 260b may be arranged below the first support aperture 260a, and center points of the first support aperture 260a and the second support aperture 260b may be aligned along a first column axis 285 extending parallel to the second direction. The first column axis 285 may extend through the first edge section 224, such that the first support aperture column 280 is aligned below the first support portion.

In some examples, the second support aperture column 284 includes the support apertures 260 including a third support aperture 260c and a fourth support aperture 260d. Furthermore, the third support aperture 260c may be arranged below the fourth support aperture 260d, and center points of the third support aperture 260c and the fourth support aperture 260d may be aligned along a second column axis 286 extending parallel to the second direction. The second column axis 286 may extend through the second edge section 228, such that the second support aperture column 284 is aligned below the second support portion.

Still referring to FIG. 3, in some examples, the support apertures 260a, 260b, 260c, 260d (e.g., slots) include and extend along a first support axis 278a, a second support axis 278b, a third support axis 278c, and a fourth support axis 278d, respectively, that is like the support axis 278. Furthermore, each of the support axes 278a, 278b, 278c, 278d may extend substantially parallel to the first direction (e.g., the elongate direction), and therefore substantially parallel to one another. In such examples, each of the support apertures 260a, 260b, 260c, 260d, or a largest dimension thereof, may extend substantially parallel to one another. Furthermore, in such examples, each of the apertures 260 of the first support aperture column 280 may extend substantially parallel to each of the apertures 260 of the second support aperture column 284.

As described above, the arms 268 can couple and secure the pipe 108 to the bracket 200. Referring to FIG. 5, in some examples, the arms 268 can extend from a first arm end 288 to a second arm end 292. As illustrated in FIG. 5, the arms 268 can define a half stadium shape (e.g., a rectangle having a single rounded end), including the first arm end 288 having a straight edge, and the second arm end 292 having a rounded edge.

In some examples, a height of the arms 268, measured along a height axis extending between the first arm end 288 and the second arm end 292, may be a largest dimension of the arms 268. Additionally, a width of the arms 268 can taper between the first arm end 288 and the second arm end 292. More specifically, the width of the arms 268, measured perpendicular to the height axis, may decrease between the first arm end 288 and the second arm end 292. However, the arms 268 may instead be any elongate shape including a rectangle, an oval, a stadium, or any other elongate shape.

The arms 268 can include a plurality of mounting apertures 296 (see, e.g., FIG. 5) that are disposed adjacent the first arm end 288. The mounting apertures 296 may receive the arm fasteners 264 to couple the arms 268 to the bracket 200. In some examples, the mounting aperture 296 can be square to selectively prevent rotation of a carriage bolt relative to the arms 268 (e.g., for improved ease and adaptability of installation).

In some examples, the mounting apertures 296 may be disposed in mounting aperture columns 300 or other vertical arrays. The mounting aperture columns 300 can be disposed along a line (e.g., a midline) extending between the first arm end 288 and the second arm end 292. Each of the mounting aperture columns 300 may include a plurality of the mounting apertures 296. As illustrated in FIG. 5, the mounting aperture columns 300 may include three of the mounting apertures 296. Specifically, the illustrated mounting aperture columns 300 may include a second mounting aperture 304, disposed between a first mounting aperture 308, and a third mounting aperture 312. As described further below, the arm fasteners 264 may be selectively moved between the mounting apertures 296 of the mounting aperture columns 300 to alter a positioning of the arm 268 relative to the bracket 200.

Still referring to FIG. 5, the arms 268 can each include an end aperture 316 disposed adjacent the second arm end 292. As described further below, the end aperture 316 can be configured to secure the flange 116 of the pipe 108 by receiving a corresponding pipe fastener 320 secured to the flange 116.

In some examples, the end aperture 316 can be shaped to accommodate various different diameters and configurations of the pipe fastener 320. For example, the end aperture 316 can include a first perimeter portion 324 that defines a first shape and a second perimeter portion 328 that defines a second shape. In some examples, the first perimeter portion 324 and the second perimeter portion 328 may intersect. Thus, generally, the end apertures 316 can exhibit compound profiles, formed by the intersecting first and second perimeter portions 324, 328.

As illustrated, each of the first perimeter portion 324 and the second perimeter portion 328 can be semi-circular in shape (e.g., a circle, a half-circle, a ¾ circle, or another fraction of a circle). In particular, the first perimeter portion 324 may define a first diameter 332 that is larger than a second diameter 336 of the second perimeter portion 328. Correspondingly, the end aperture 316 can be formed by the first and second perimeter portions 324, 328 as compound circular apertures (e.g., generally as keyhole slots, as shown). However, the first and second perimeter portions 324, 328 may instead define a shape that is rectangular, triangular, ovular, or any other applicable shape. In such examples, the end aperture 316 can be a compound shape formed by the first and second perimeter portions 324, 328 having a variety of different shapes and sizes.

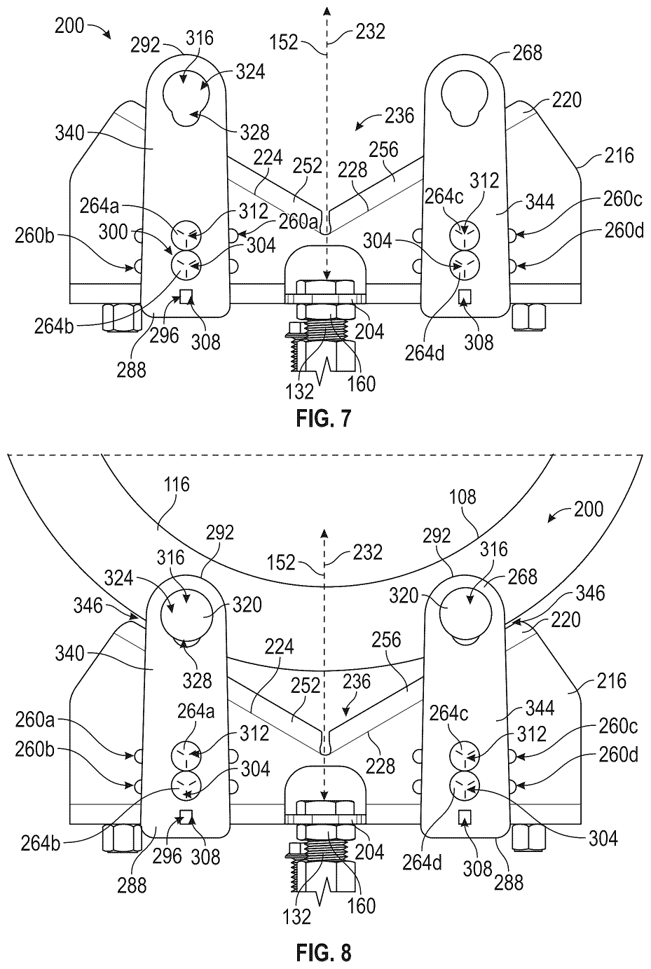

In some examples, as generally discussed above, perimeters of the first and second perimeter portions 324, 328 may intersect, to form a compound profile for the end aperture 316 that is capable of receiving multiple types and diameters of the pipe fastener(s) 320 (e.g., a fastener extending through apertures disposed in the flange 116 of the pipe 108). Specifically, the second perimeter portion 328 may accept and retain a pipe fastener having a smaller diameter shank or threading, while the first perimeter portion 324 may accept and retain a pipe fastener having a larger diameter shank or threading. As described further below, based on the diameter of the pipe fastener 320, the pipe fastener 320 may be movable between the first perimeter portion 324 and the second perimeter portion 328. As also discussed below, when the arms 340, 344 extend upwardly from the bracket 200 (e.g., when the end apertures 316 are disposed above at least a portion of the first or second support portion, relative to gravity as illustrated in FIG. 7), the second perimeter portion 328 may be disposed below (e.g., vertically below relative to gravity) the first perimeter portion 324. In such examples, the pipe fasteners having a smaller diameter that are inserted into the end apertures 316 will fall into the second perimeter portion 328 due to gravity, while the pipe fasteners having a larger diameter that are inserted into the end apertures 316 will remain secured within the first perimeter portion 324.

Referring to FIGS. 5-8, the arms 268 can be secured to the bracket 200 in a plurality of orientations to selectively configure the bracket 200 to support various configurations of pipes and pipe systems. As illustrated in FIG. 5, the arm fasteners 264 may secure the arms 268 to the bracket 200 in a first arm position. Specifically, a first arm 340 of the arms 268 can be secured to the bracket 200 using arm fasteners 264a, 264b that may extend through the first and second mounting apertures 308, 304 of the first arm 340, respectively, and that may also extend through the support apertures 260a, 260b of the first support aperture column 280, respectively. Additionally, a second arm 344 of the arms 268 can be secured to the bracket 200 using arm fasteners 264a, 264b that may extend through the first and second mounting apertures 308, 304 of the second arm 344, respectively, and that may also extend through the support apertures 260c, 260d of the second support aperture column 284, respectively.

In the first arm position, the first arm 340 may be rotationally fixed relative to the bracket 200, however the arm fasteners 264a, 264b may be translatable within the support apertures 260a, 260b, to allow a position of the first arm 340 to be translated (e.g., slid) along the first direction relative to the bracket 200. Furthermore, in the first arm position, the second arm 344 may be rotationally fixed relative to the bracket 200, however the arm fasteners 264c, 264d may be translatable within the support apertures 260c, 260d, to allow a position of the second arm 344 to be translated (e.g., slid) along a third direction, substantially parallel to the first direction relative to the bracket 200. Additionally, in the first arm position, the arms 268 may extend from the first arm end 288 to the second arm end 292 in a direction that is toward the first wall 204. More specifically, in the first arm position, the first and second arms 340, 344 may extend from the first arm end 288 to the second arm end 292 in a direction that is downward, with respect to gravity. In some examples, the arms 268 may extend in the direction that is substantially parallel to the centerline 232 of the bracket 200. Thus, for example, the arms 340, 344 can be secured to the bracket 200 without interfering with support of a pipe on the upper edge 220 of the bracket 200.

As illustrated in FIG. 6, at least one of the arm fasteners 264 that attaches the first arm 340 to the bracket 200 and at least one of the arm fasteners 264 that attaches the second arm 344 to the bracket 200 may be removed to allow the arms 340, 344 to be adjusted from the first arm position to a second arm position. Specifically, the arm fastener 264a extending through the first mounting aperture 308 of the first arm 340 and the first support aperture 260a of the second wall 216, as well as the arm fastener 264c extending through the first mounting aperture 308 of the second arm 344 and the third support aperture 260c of the second wall 216 may each be removed. The first arm 340 and the second arm 344 may then be rotated relative to the bracket 200 (e.g., about the arm fasteners 264b, 264d extending through the second mounting apertures 304 of each of the first arm 340 and the second arm 344. More specifically, the first arm 340 and the second arm 344 may be rotated to the second arm position illustrated in FIG. 7.

Referring to FIG. 7, the arm fasteners 264a, 264c may secure the arms 268 to the bracket 200 in the second arm position. Specifically, the first arm 340 can be secured to the bracket 200 using the arm fasteners 264b, 264a that may extend through the second and third mounting apertures 304, 312 of the first arm 340, respectively, and that may also extend through the support apertures 260b, 260a of the first support aperture column 280, respectively. Additionally, the second arm 344 can be secured to the bracket 200 using the arm fasteners 264c, 264d that may extend through the second and third mounting apertures 304, 312 of the second arm 344, respectively, and that may also extend through the support apertures 260d, 260c of the second support aperture column 284, respectively.

In the second arm position, the first arm 340 and the second arm 344 may be rotationally fixed relative to the bracket 200. More specifically, the first arm 340 and the second arm 344 may extend substantially perpendicular to the first direction (e.g., the elongate direction) toward the upper edge 220 of the second wall 216. In such examples, the first arm 340 and the second arm 344 may extend upward and vertically (e.g., relative to gravity) beyond the first and second support portions, respectively. More specifically, the first and second arms 340, 344 extend away from the arm fasteners 264 to the second arm ends 292 and the end apertures 316 of the first and second arms 340, 344 that are disposed above at least a portion of the first and second support portions, respectively. Furthermore, in such examples, the height of the first and second arms 340, 344 (e.g., the largest dimension thereof) may extend perpendicular to the first direction and parallel to the centerline 232 of the bracket 200.

Although the arms 340, 344 are rotationally fixed relative to the bracket 200 in the second arm position, the arm fasteners 264 may be translatable within the support apertures 260, to allow a position of the first arm 340 and the second arm 344 to be adjusted relative to the bracket 200. For example, the first and second arms 340, 344 may be translatable along the first direction (e.g., the elongate direction) or the third direction.

Referring to FIGS. 3 and 7, in both the first and second arm positions, the first arm 340 may be slidable or translationally adjustable along one or more of the first and second support apertures 260a, 260b. In some examples, each of the first and second support apertures 260a, 260b may define a first support aperture end and a second support aperture end, opposite the first support aperture end, along the first direction, or along the respective first and second axes 278a, 278b thereof (see specifically FIG. 3). Furthermore, the first and second apertures 260a, 260b can define a first range of arm positions between the first and second ends of the apertures 260a, 260b. More specifically, the first and second arm fasteners 264a, 264b can secure the first arm 340 to the first or second support apertures 260a, 260b at a plurality of arm positions along the first range of arm positions. In some examples, the first range of arm positions can be continuous, allowing the first arm 340 to be secured to the first or second support apertures 260a, 260b at any position or location along the first range of arm positions. In such examples, the first arm 340 may be infinitely adjustable between the first and second ends of the apertures 260a, 260b. More specifically, the first and second arm fasteners 264a, 264b can be slid to any position or location along the first range of arm positions to provide for infinite adjustability of the first arm 340 between the first and second ends of the apertures 260a, 260b.

Similarly, in both the first and second arm positions, the second arm 344 may be slidable or translationally adjustable along one or more of the third and fourth support apertures 260c, 260d. In some examples, each of the third and fourth support apertures 260c, 260d may define a third support aperture end and a fourth support aperture end, opposite the third support aperture end, along the first direction, or along the respective third and fourth axes 278c, 278d thereof (see specifically FIG. 3). Furthermore, the third and fourth apertures 260c, 260d can define a second range of arm positions between the third and fourth ends of the apertures 260c, 260d. More specifically, the third and fourth arm fasteners 264c, 264d can secure the second arm 344 to the third or fourth support apertures 260c, 260d at a plurality of arm positions along the second range of arm positions. In some examples, the second range of arm positions can be continuous, allowing the second arm 344 to be secured to the third or fourth support apertures 260c, 260d at any position or location along the second range of arm positions. In such examples, the second arm 344 may be infinitely adjustable between the third and fourth ends of the apertures 260c, 260d. More specifically, the third and fourth arm fasteners 264c, 264d can be slid to any position or location along the second range of arm positions to provide for infinite adjustability of the second arm 344 between the third and fourth ends of the apertures 260c, 260d.

Therefore, the first and second arms 340, 344 are individually slidably adjustable to collectively provide a plurality of support configurations for the pipe 108 with the first and second arms at any arm position along the respective first or second ranges of arm positions. The infinite adjustability of the arms 340, 344 along the first and second ranges of arm positions increases the compatibility of the bracket 200 with a variety of different sizes and configurations of pipes and pipe flanges, advantageously increasing the versatility of the bracket 200. In some examples, in the second arm position, regardless of a position of the first and second arms 340, 344 along the first or second ranges of arm positions, the second arm ends 292 of the first and second arms 340, 344 can be positioned above the support surface (e.g., the first and second support portions, respectively), to allow the end apertures 316 to receive the pipe fasteners 320 to secure the flange 116 of the pipe 108 to the arms 340, 344, as described further below.

Referring to FIG. 8, in a first pipe installation configuration, the first arm 340 and the second arm 344 may be disposed in the second arm position. In the first pipe installation configuration, the end apertures 316 of the arms 268 may each receive and retain the pipe fasteners 320 of the flange 116. As illustrated in FIG. 8, the pipe fastener 320 may extend through flange apertures, disposed in the flange 116 of the pipe 108, and may be retained by the end apertures 316 to secure the pipe 108 to the bracket 200. As described above, the arms 268 can be adjusted relative to the bracket 200. The arms 268 may be adjusted translationally relative to the bracket 200 to align the end apertures 316 with the flange apertures that are offset at various different distances (e.g., about pipes having various different diameters).

As illustrated in FIG. 8, the pipe fasteners 320 may be retained within the first perimeter portion 324 due to a diameter of a threading or shank of the pipe fasteners 320. However, the pipe fasteners 320 having a smaller diameter threading or shank may instead rest within the second end aperture 328. The second perimeter portion 328 may help to mitigate movement of the smaller diameters pipe fasteners 320 within the end aperture 316. Specifically, the smaller diameter pipe fasteners 320 retained within the second perimeter portion 328 may be less likely to shift or roll, as a size of the second perimeter portion 328 may conform more closely to the size of the smaller diameter pipe fasteners 320. Consequently, the end apertures 316 including the first perimeter portion 324 and the second perimeter portion 328 better retains the pipe fasteners 320 of a range of diameters and types, and increases the variety of types and sizes of the pipes 108 (e.g., and the pipe fastener 320 thereof) that can be secured to the bracket 200. As described above, in the second arm position, the pipe fasteners 320 having a smaller diameter that are inserted into the end apertures 316 will fall into the second perimeter portion 328 due to gravity, while the pipe fasteners 320 having a larger diameter that are inserted into the end apertures 316 will remain secured within the first perimeter portion 324.

Still referring to FIG. 8, in some examples, in the first pipe installation configuration, the arms 340, 344 may be coupled to the pipe 108 and may be the only points of contact between the bracket 200 and the pipe 108. More specifically, the arms 340, 344 may support the pipe 108 so that so that a gap 346 is defined between the pipe 108 and the support surface (e.g., the edge sections 224, 228 and the lips 252, 256) and the notch 236. In such examples, the lack of rotational adjustment of the arms 340, 344 in the second position may advantageously ensure that the arms 340, 344 remain fixed in place, or are otherwise not accidentally adjusted, and may provide a more secure and stable support for the pipe 108.

In other examples, in the first pipe installation configuration, the arms 340, 344 may be coupled to the pipe 108, however, the pipe 108 may also rest and be retained by the support surface in the notch 236. In such examples, the pipe 108 may contact the bracket 200 at four or more points of contact, and may be locked against rotational or translational movement relative to the bracket 200.

Referring briefly to FIG. 2, in a second pipe installation configuration, the first arm 340 and the second arm 344 may be disposed in the first arm position. In the second pipe installation configuration, the bracket 200 may be configured to receive and secure the extension of the pipe 108 (e.g., between the flanges 116). Specifically, the extension of the pipe 108 may rest within the notch 236 of the bracket 200, contacting the support surface, and the U-bolt 212, extending around the pipe 108, may be tightened to the bracket 200 via the securement nuts 208.

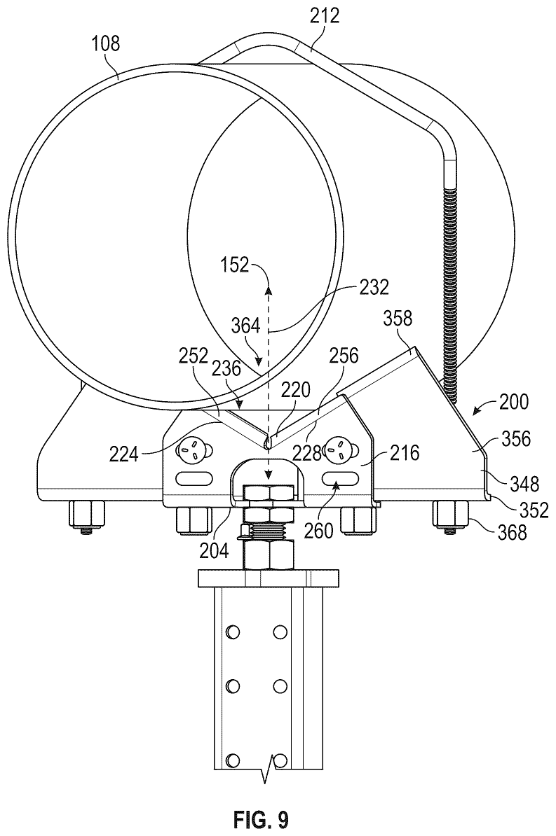

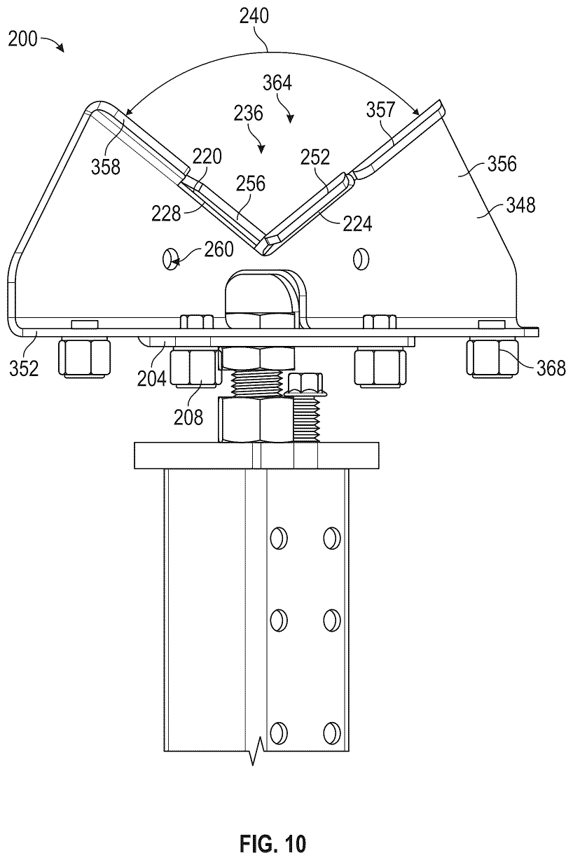

Referring to FIGS. 9 and 10, in some examples, the bracket 200 may include a bracket extension 348 to aid the retention of larger sized pipe. As shown in FIG. 10 in particular, a shape of the bracket extension 348 may be similar to the bracket 200, including a first extension wall 352 (e.g., an extension base), and a second extension wall 356 extending upward to an upper extension end. In some examples, the second extension wall 356 can extend to a first extension edge 357 and to a second extension edge 358, which cooperatively form an extension notch 364. The first extension edge 357 can form a first extension support portion and the second extension edge 358 can form a second extension support portion. In some examples, the first extension edge 357 can be angularly offset from the second extension edge 358 by the angle 240. In other examples, the first extension edge 357 and the second extension edge 358 can otherwise be non-parallel relative to one another. Furthermore, the angle 240 between the first extension edge 357 and the second extension edge 358 can match or otherwise be equal to the angle 240 between the first edge section 224 and the second edge section 228 of the bracket 200.

The bracket extension 348 can be secured to the bracket 200 via fasteners extending through the second extension wall 356 and the second wall 216 (e.g., through the support apertures 260). The bracket extension 348 may further be secured to the bracket 200 via fasteners extending through the first extension wall 352 and the first wall 204 (e.g., through the securement apertures and the securement nuts 208 as shown in FIG. 10).

Via installation onto the bracket 200, the bracket extension 348 may increase a size of the bracket 200 (e.g., increase a lateral width, perpendicular to the centerline 232, as shown). Specifically, the second extension wall 356 may each conform to a shape of the second wall 216, and may extend farther from the centerline 232 than the second wall 216, and the upper edge 220 thereof. Consequently, the bracket extension 348 may effectively increase a size (e.g., lateral width and height) of the notch 236. Specifically, when installed, the first extension edge 357 may extend from the first edge section 224 and away from the centerline 232, and the second extension edge 358 may extend from the second edge section 228 away from the centerline 232 (e.g., at angles consistent with the first edge angle 244 and the second edge angle 248) to increase a size of the notch 236, allowing larger diameters of the pipe 108 to rest and be secured within the notch 236. In such examples, the upper extension end of the bracket extension 348 and the upper end of the bracket 200 cooperatively define the support surface for the pipe 108, to increase a size of the support surface for the pipe 108, and to allow the bracket 200 to secure and retain larger diameters of the pipe 108.

In some examples, the bracket extension 348 may include extension securement nuts 368 disposed farther from the centerline 232 than the securement nuts 208 of the bracket 200, allowing the bracket extension 348 to secure larger sizes of the U-bolt 212, and therefore allowing the bracket 200 to secure larger diameters of the pipe 108.

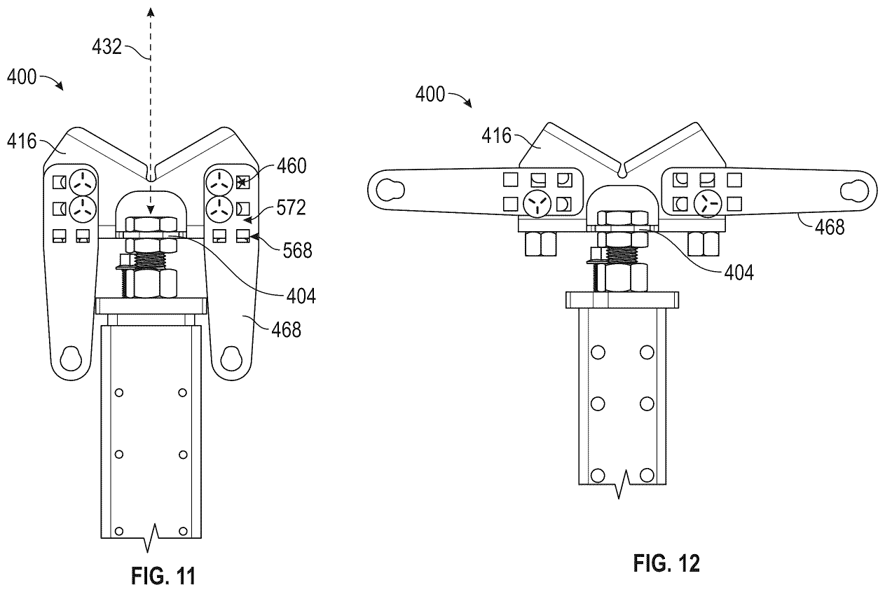

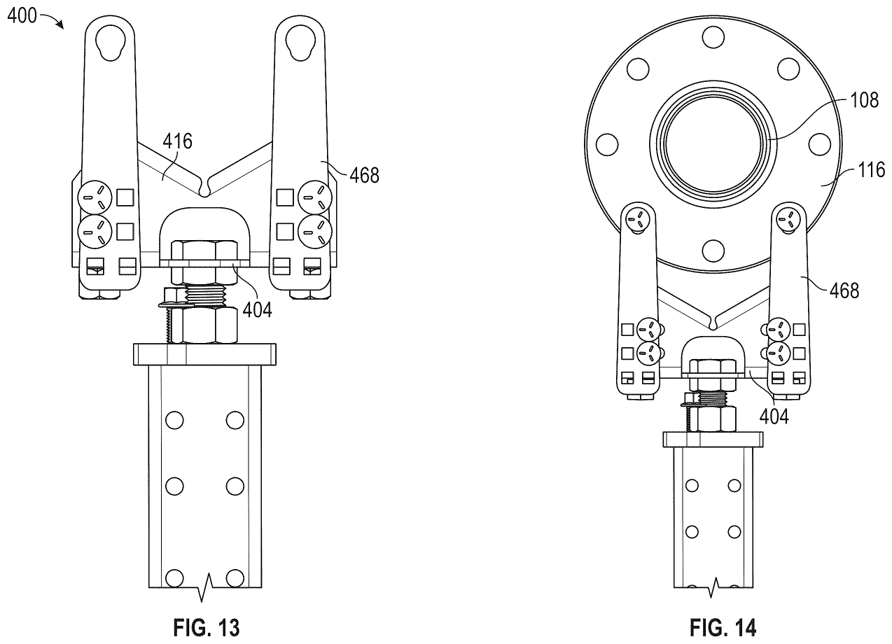

In some configurations, a bracket can include an alternate design of arms for securing a flange of a pipe. In this regard, for example, FIGS. 11-14 illustrate another embodiment of a bracket 400. The bracket 400 of FIGS. 1-10 may generally include similar features as the bracket 200 of FIGS. 1-10, including but not limited to a first wall 404, a second wall 416, a centerline 432, arms 468, the arms 468 including a plurality of support apertures 460. Thus, discussion of the bracket 200 above also generally applies to similar components of the bracket 400 (and vice versa).

As illustrated in FIGS. 11-14, the arms 468 may include the plurality of the support apertures 460 disposed in support aperture columns 568 and support aperture rows 572. As illustrated, the support aperture columns 568 may include two columns, and the support aperture rows 572 may include three rows. However, the arms 468 may instead include any number of the support aperture rows 572 and the support aperture columns 568. Including more of the support aperture rows 572 may increase an adjustability of the arms 468 along a direction that is substantially parallel to the centerline 232 of the bracket 400. Including more of the support aperture columns 568 may increase an adjustability of the arms 468 along a direction that is substantially perpendicular to the centerline 432 of the bracket 400. Thus, as generally shown in FIGS. 1-14, the arms 468 can provide a wide range of mounting configurations to accommodate a wide range of pipe and pipe-flange diameters and related fastener spacings.

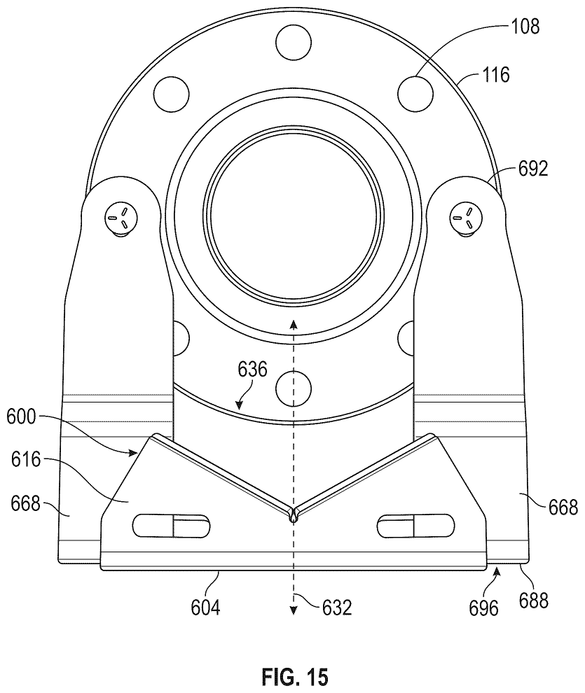

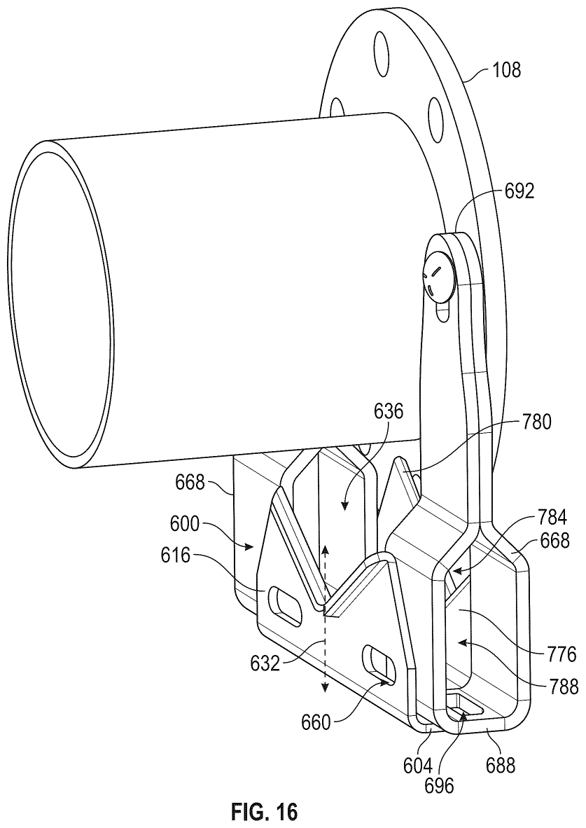

In some configurations, a bracket can include an alternate design. In this regard, for example, FIGS. 15 and 16 illustrate another embodiment of a bracket 600. The bracket 600 of FIGS. 15 and 16 may generally include similar features as the bracket 200 of FIGS. 1-10 and the bracket 400 of FIGS. 11-14, including but not limited to a first wall 604, a second wall 616 defining a notch 636, a centerline 632, and arms 668 extending from a first arm end 688 to a second arm end 692. Thus, discussion of the brackets 200, 400 above also generally applies to similar components of the bracket 600 (and vice versa).

Referring to FIG. 16, in some examples, the bracket 600 can include a third wall 776 extending from the first wall 604 opposite the second wall 616. In some examples, the third wall 776 may be substantially identically to the second wall 616. Specifically, the third wall 776 can extend from the first wall 604 to a second upper edge 780 that defines a second notch 784 having a substantially identical shape as the notch 636. Including a third wall 776 having a second notch 784 can increase a number of contact points between the pipe 108 and the bracket 600 supporting the pipe 108.

In some examples, a channel 788 can be defined by the first wall 604, the second wall 616, and the third wall 776. The channel 788 can retain and secure the first arm end 688 of the arms 668, to couple the arms 668 to the bracket 600. In some embodiments, support apertures 660 disposed in the first wall 604 may receive and retain arm fasteners that extend through mounting apertures 696 disposed at the first arm end 688. The support apertures 660 may be elongate in shape to the allow the arms 668 to be adjusted (e.g., translated) within the channel 788.

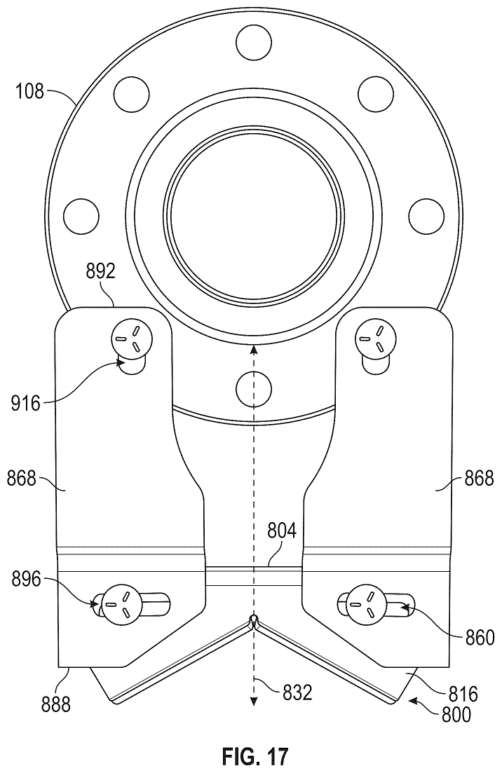

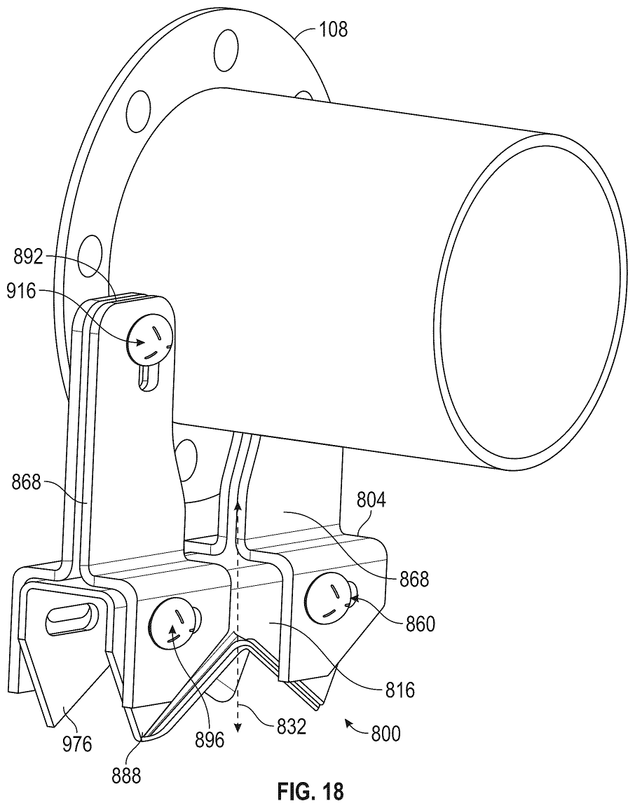

In some configurations, a bracket can include arms having an alternate design. In this regard, for example, FIGS. 17 and 18 illustrate another embodiment of a bracket 800. The bracket 800 of FIGS. 17 and 18 may generally include similar features as the bracket 200 of FIGS. 1-10, the bracket 400 of FIGS. 11-14, and the bracket 600 of FIGS. 15 and 16, including but not limited to a first wall 804, a second wall 816, a third wall 976, a centerline 832, and arms 868 extending from a first arm end 888 to a second arm end 892. Thus, discussion of the brackets 200, 400, 600 above also generally applies to similar components of the bracket 800 (and vice versa).

Referring to FIG. 18, in some examples, the bracket 800 may be rotated, such that the second wall 816 and the third wall 976 extend away from the pipe 108. The arm 668 may extend around and partially encompass the first wall 804, the second wall 816, and the third wall 976. In some examples, support apertures 860 disposed in the second wall 816 or the third wall 976 may receive and retain arm fasteners that may extend through mounting apertures 896 disposed adjacent the first arm end 888. The arm 268 may extend from the first end 888 toward the first wall 804. Consequently, a end aperture 916 may be disposed on an opposite side of the first wall 804, relative to the mounting apertures 896, to receive and retain the pipe fasteners 320 for securing the pipe 108 to the bracket 800.

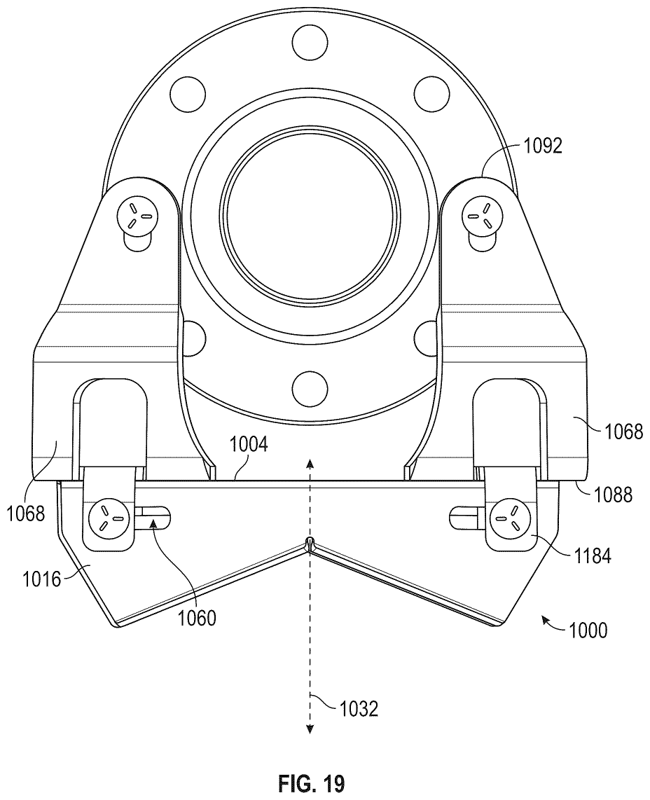

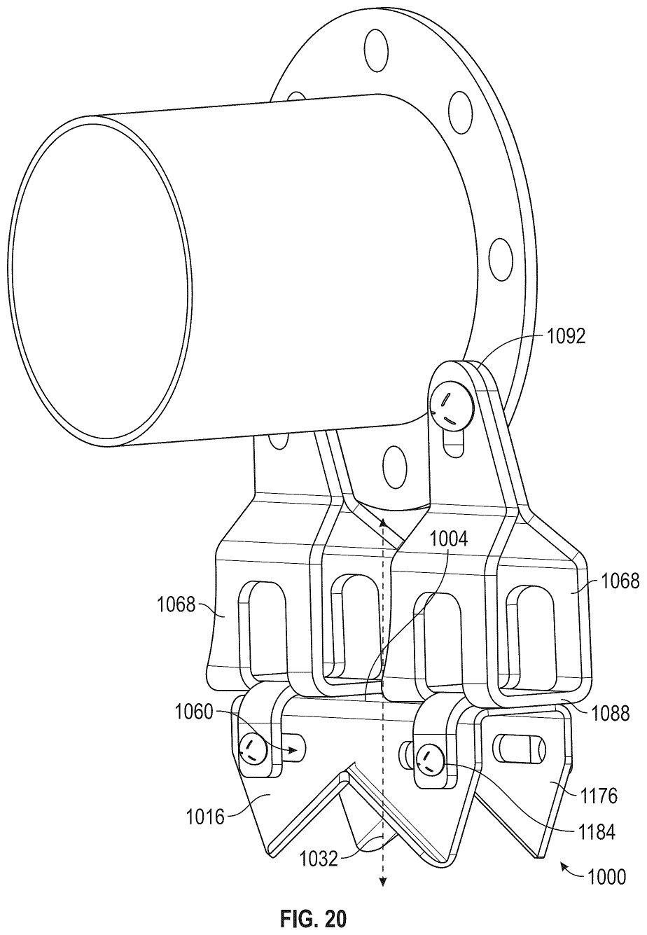

In some configurations, a bracket can include arms having an alternate design. In this regard, for example, FIGS. 19 and 20 illustrate another embodiment of a bracket 800. The bracket 800 of FIGS. 19 and 20 may generally include similar features as the bracket 200 of FIGS. 1-10, the bracket 400 of FIGS. 11-14, the bracket 600 of FIGS. 15 and 16, and the bracket 800 of FIGS. 17 and 18, including but not limited to a first wall 1004, a second wall 1016, a third wall 1176, a centerline 1032, and arms 1068 extending from a first arm end 1088 to a second arm end 1092. Thus, discussion of the brackets 200, 400, 600, 800 above also generally applies to similar components of the bracket 1000 (and vice versa).

Referring to FIG. 20, in some examples, the bracket 1000 may be rotated, such that the second wall 1016 and the third wall 1176 extend away from the pipe 108. The first arm end 1088 may rest on a side of the first wall 1004 opposite the second wall 1016 and the third wall 1176. The arm 1068 may include tabs 1184 extending from the first arm end 1088 that extend around and partially encompass the first wall 1004, the second wall 1016, and the third wall 1176. In some examples, support apertures 1060 disposed in the second wall 1016 or the third wall 1176 may receive and retain arm fasteners that extend through the tabs 1184. The arm 1068 may extend from the first wall 1004 in a direction opposite the extension of the second wall 1016.

Thus, examples of the disclosed technology can provide improved support systems for supporting equipment above rooftops or other support surfaces. For example, use of a bracket as detailed above, along with various associated sub-assemblies, can allow for easy and adaptable modular assembly of a variety of support structure configurations to support pipes having a variety of diameter, and to support the pipes at any location along the pipe.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Throughout the disclosure, the terms “about” and “approximately” mean plus or minus 5% of the number that each term precedes, inclusive. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive. Likewise, unless otherwise limited or defined, “substantially radial” indicates a direction that is within ±12 degrees of radial a reference direction (e.g., within ±6 degrees or ±3 degrees), inclusive. Likewise, unless otherwise limited or defined, “substantially axial” indicates a direction that is within ±12 degrees of axial a reference direction (e.g., within ±6 degrees or ±3 degrees), inclusive.

Also as used herein, unless otherwise limited or defined, “substantially identical” indicates that features or components are manufactured using the same processes according to the same design and the same specifications. In some cases, substantially identical features can be geometrically congruent.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order

What is claimed is:

1. A support system for pipes, the support system comprising:
a base;
a post secured to and extending upwardly from the base; and
a bracket secured to the post and supported by the post relative to the base, the bracket including:
a bracket body including a support wall and a base secured to the post, the support wall extending integrally from the base, and including:
an upper end defining a first support section and a second support section that extends at a non-parallel angle relative to the first support section so that the first and second support sections collectively define a support surface for a pipe;
including first parallel slots extending through the support wall below the first support section of the upper end; and
including second parallel slots extending through the support wall below the second support section of the upper end;
a first arm including a first aperture to receive a first fastener to secure a pipe flange, the first arm being secured at the first parallel slots and slidable along the first parallel slots to provide a first continuous range of arm positions; and
a second arm including a second aperture to receive a second fastener to secure the pipe flange, the first arm being secured at the second parallel slots and slidable along the second parallel slots to provide a second continuous range of arm positions, so that the first and second arm are individually slidably adjustable to collectively provide a plurality of first support configurations for the pipe with the first and second arms at any arm position along the respective first or second continuous ranges of arm positions.

2. The support system of claim 1, wherein the first parallel slots are substantially parallel to the second parallel slots.

3. The support system of claim 1, wherein the first parallel slots include a first slot and a second slot, aligned below the first support section; and
wherein the second parallel slots include a third slot and a fourth slot, aligned below the second support section.

4. The support system of claim 3, wherein the first, second, third, and fourth slots are linear slots that define, respectively, first, second, third, and fourth axes along an elongate direction, the first, second third, and fourth axes being substantially parallel with each other.

5. The support system of claim 1, wherein the first arm is secured to the bracket body with a first fastener received through and slidable along a first slot of the first parallel slots and with a second fastener received through and slidable along a second slot of the first parallel slots; and
wherein the second arm is secured to the bracket body with a third fastener received through and slidable along the third slot and with a fourth fastener received through and slidable along the fourth slot.

6. The support system of claim 1, wherein the first arm and the second arm extend substantially vertically from the first and second parallel slots, respectively, to fastening apertures that are disposed above the first and second support sections to secure the first and second arms to a pipe flange.

7. The support system of claim 1, wherein one or more of the first arm or the second arm includes, respectively, a fastening aperture configured to receive a fastener to secure a pipe, the fastening aperture including a first circular perimeter portion with a first diameter and a second circular perimeter portion with a second diameter smaller than the first diameter.

8. The support system of claim 7, wherein, with the one or more of the first or second arm extending upwardly from the corresponding first or second parallel slots, the respective fastening aperture is above the support surface and the first circular perimeter portion is above the second circular perimeter portion.

9. The support system of claim 1, further comprising:
the pipe;
wherein in the first support configurations, the pipe is supported by the first and second arms so that a gap is defined between the pipe and the support surface; and
wherein the first and second arms are securable in second support configurations, in which the pipe rests on the support surface.

10. The support system of claim 9, wherein, in the second support configurations, the first and second arms are slidably secured to extend downwardly from, respectively, the first and second parallel slots.

11. A support system for pipes, the support system comprising:
a bracket that includes a bracket body and one or more arms fastened to the bracket body;
the bracket body including a support wall extending to an upper bracket end that defines a support surface for a pipe; and
the one or more arms including:
a first arm fastened to the support wall with a first fastener extending through a first support aperture of the support wall,
the first arm extending away from the first fastener to a first free end with a first end aperture configured to secure a pipe flange, and
the first arm being slidable along the first support aperture over a first continuous range of arm positions and the first fastener being operable to secure the first arm at any position along the first continuous range of arm positions, including first arm positions that align the first free end of the first arm above the support surface to support the pipe flange.

12. The support system of claim 11, wherein the one or more arms further includes:
a second arm fastened to the support wall with a second fastener extending through a second support aperture of the support wall,
the second arm extending away from the second fastener to a second free end with a second end aperture configured to secure the pipe flange, and
the second arm being slidable along the second support aperture over a second continuous range of arm positions and the second fastener being operable to secure the second arm at any position along the second continuous range of arm positions, including second arm positions that align the second free end of the second arm above the support surface to support the pipe flange.

13. The support system of claim 12, wherein the first aperture defines a first elongate slot that extends along a first axis, wherein the second aperture defines a second elongate slot that extends along a second axis, and wherein the first axis and the second axis extend substantially parallel to one another in an elongate direction.

14. The support system of claim 11, further comprising:
a first column of support apertures disposed in the support wall, the first column of support apertures including the first support aperture that receives the first support fastener and a second support aperture configured to selectively receive a second support fastener to secure the first arm to the support wall;
a second column of support apertures disposed in the support wall, the second column of support apertures including a third support aperture that receives a third support fastener and a fourth support aperture configured to selectively receive a fourth support fastener to secure a second arm to the support wall.

15. The support system of claim 11, wherein the first arm is slidable along the first support aperture in a first direction, and
wherein, in the first arm positions, a largest dimension of the first arm extends substantially perpendicular to the first direction.

16. The support system of claim 11, wherein the first end aperture includes a first circular perimeter portion to receive a first pipe fastener having a first diameter, and a second circular perimeter portion to receive a second pipe fastener having a second diameter, and wherein the first circular perimeter portion and the second circular perimeter portion intersect.

17. The support system of claim 11, further comprising a bracket extension including an extension body having an extension wall extending to an upper extension end, the bracket extension being configured to nest with the support wall of the bracket body such that the upper extension end cooperatively defines the support surface with the upper bracket end to increase a width of the support surface for the pipe beyond a width of the bracket body.

18. A method for securing a pipe to a support system, comprising:
providing a bracket including:
a bracket body including a support wall extending to an upper bracket end that defines a support surface for a pipe; and
one or more arms fastened to the bracket body, including a first arm of the one or more arms fastened to the support wall with a first fastener extending through a first support aperture of the support wall, the first fastener being operable to secure the first arm at any position along a first continuous range of arm positions, and the first arm extending away from the first fastener to a first free end with a first end aperture configured to secure a pipe flange;
sliding the first arm along the first support aperture over the first continuous range of arm positions; and
securing the first arm with the first fastener at a first arm position along the first continuous ranges of arm positions that aligns the first free end of the first arm above the support surface to support the pipe flange.

19. The method of securing the pipe to the support system of claim 18, further comprising:
securing the first arm at a second arm position;
wherein in the first arm position, the pipe is configured to be supported by the first arm so that a gap is defined between the pipe and the support surface; and
wherein in the second arm position, the pipe is configured to rest on the support surface.

20. The method of securing the pipe to the support system of claim 18, further comprising:
sliding a second arm along a second support aperture of the support wall, the second arm being fastened to the support wall with a second fastener extending through the second support aperture, the second arm extending away from the second fastener to a second free end with a second end aperture configured to secure a pipe flange; and
securing the second arm at a second arm position that aligns the second free end of the second arm above the support surface to support the pipe flange,
wherein first arm is slid along the first support aperture along a first direction,
wherein the second arm is slid along the second support aperture along a second direction, and
wherein the first direction is substantially parallel to the second direction.
